(19) United States
(12) Patent Application Publication
(10) Pub. No.: US 2008/0289890 A1
(43) Pub. Date: Nov. 27, 2008

(54) WHEEL-DRIVEN BATTERY CHARGER

(76) Inventor: John Stoltzfus, Lebanon, PA (US)

Correspondence Address: ANDREW D. MEAD, ATTORNEY AT LAW, P. O. BOX 415, BROWNSTOWN, PA, 17508-0415, US

(21) Appl. No.: 11/754,061

(22) Filed: May 25, 2007

(51) Int. Cl. B60L 1/00

(52) U.S. Cl. 180/65.3

(57) ABSTRACT

An improved battery charging system for use on a non-motorized, ground-supported wheeled vehicle such as a horse-drawn buggy, including a generator incorporated into the hub assembly of at least one wheel, a voltage control unit for controlling the voltage output of the generator over the full range or vehicle speeds, and a battery. The synchronous generator features rare earth metal permanent magnets arranged in a three-phase, outside rotor disposed within a wheel brake housing of a buggy wheel hub. The stator is situated on an axle. Voltage regulation includes active switching whereby generator output voltage is rectified during low vehicle speed operation and an increasing portion directed away from the battery as vehicle speed and thus generator output voltage increases to a level which could damage the connected battery.

### BACKGROUND OF THE INVENTION

The present invention relates generally to a generator and control apparatus for charging a battery and more particularly to a non-friction, wheel-driven generator for charging a battery on a non-motorized wheeled vehicle.

The use of horse-drawn vehicles as a means of transportation continues today in surprising numbers. One significant constituency relying on horse-drawn vehicles as a means of transportation is people observing certain practices as a means of maintaining their religious beliefs. Many “plain sect” religions (Anabaptist), including Amish and Mennonite, eschew motorized vehicles in favor of horse-drawn carriages, buggies, and wagons in support of their religious practices. As these vehicles are routinely used on public roads, they are required to have certain safety equipment. Nighttime operation requires the use of lights, both forward aimed to illuminate the road ahead and allow the vehicle to be seen, and rearward aimed to alert drivers approaching from behind. Lacking an engine and electrical system of a typical automobile, these vehicles rely on deep-cycle batteries that must be periodically removed and recharged to provide lighting needs. Lighting run times are limited due to the inconvenience of recharging the battery. As a result, daytime or constant illumination lighting is rarely used, in spite of the safety improvements resulting from daytime running lights. Operators of these non-motorized vehicles wanting some form of on-vehicle battery charging are forced to rely on poorly adapted automotive-style battery charging systems which offer generally poor performance in the low-speed environment of a horse-drawn vehicle.

The use of a wheel-driven generator on non-motorized vehicles is known. Generator dynamos are generally rotatably connected to a wheel or axle in a manner to cause the generator to turn by rotation of a wheel in order to produce electric power. Additionally, bicycles may use dynamos driven by a friction contact with a tire to power lights while riding. Applications on animal-propelled vehicles are also known, but typically include a small generator optimized for relatively higher speed operation (input speed on the order of hundreds of rpm) with a friction or belt drive connecting the generator to a rotating portion of a wheel to provide a suitable drive ratio.

These types of generators generally impose significant drag on the vehicle relative to the power output provided. The rotational interface between the vehicle wheels and the generator is also susceptible to failure. Friction drives, in which a roughened driven wheel connected to the generator input shaft is positioned in contact with a rotating portion of a wheel, usually a tire sidewall, accelerates tire wear. Systems using belts or chains to transfer rotational motion to the generator input shaft introduce complexity to the system and may result in an apparatus that is failure-prone under harsh conditions or without frequent maintenance.

Non-motorized vehicles are generally limited in their maximum speed, but may experience a wide range of operational speeds. This presents two significant challenges for a generator used to charge a battery. The first challenge is generating sufficient power and voltage at relatively low vehicle speeds, as low as a 1 mph. In a nominal 12 volt system commonly used for vehicular lighting systems, a battery charging voltage of 14 volts must be applied or no appreciable charging of the battery will occur. Meeting this objective requires an efficient generator system optimized for relatively low speed operation. The second challenge presented is limiting voltage and power of the efficient low speed optimized generator at relatively high vehicle speeds ranging from 10 to 25 mph. A generator efficient at low speed will produce voltages exceeding the upper limits of battery charging and potentially damage the battery, charging circuit, or both. Common practice is to optimize the generator for low-speed operation and incorporate a field weakening voltage regulator to limit voltage output during higher speed operation. The practice decreases efficiency of the system and limits the total power output of the generator system.

It would be a great advantage to provide a cost-effective and reliable system for charging an on-board battery on a non-motorized, animal-drawn vehicle that utilizes motion of the vehicle itself to power an on-board generator and charging circuit for recharging an on-board battery that overcomes the above problems and disadvantages.

### SUMMARY OF THE INVENTION

Accordingly, it is an object of the present invention to provide a non-friction electrical generation system for use on a non-motorized vehicle for charging an on-board battery or powering other on-board electrical loads, such as lights.

It is a further object of the present invention to provide a generator for a battery charging system that can be integrated into a wheel hub for direct drive as the wheel rotates.

It is a further object of the present invention to provide an electric current generator capable of producing sufficient power to operate a battery charging system with relatively low rotational speeds associated with animal drawn vehicles, particularly horse-drawn carriages.

It is a further object of the present invention to provide a battery charging system for an animal drawn vehicle creates relatively low drag on the vehicle.

It is a further object of the present invention to provide a battery charging system for a non-motorized vehicle that regulates output voltage of the generator to levels suitable for charging a battery under a wide range of generator rotational speeds.

It is a still further object of the present invention to provide a battery charging system for a non-motorized vehicle capable of powering on on-board lighting system thereby enhancing vehicle safety while operating on public roadways during non-daylight conditions.

It is a still further object of the present invention to provide a wheel-driven generator for a battery charging system on a horse-drawn vehicle that can be easily integrated into an existing wheel hub design that does not require alteration of the wheel hub.

It is a still further object of the present invention to provide a wheel-driven battery charging system that can be selectively configured to provide regenerative braking for the vehicle.

It is a still further object of the present invention to provide a wheel-driven battery charging system for an animal drawn vehicle that is durable in construction, inexpensive of manufacture, carefree of maintenance, easily assembled, and simple and effective to use.

These and other objects are achieved by providing an improved battery charging system for use on a non-motorized, ground-supported wheeled vehicle, such as a horse-drawn buggy, including a generator incorporated into the hub assembly of at least one wheel., a voltage regulator for controlling the voltage output of the generator over the full range or vehicle speeds and a battery. The synchronous generator features rare earth metal permanent magnets arranged in a three-phase, outside rotor disposed within a wheel brake housing of a buggy wheel hub. The stator is situated on an axle. Voltage regulation includes active switching whereby generator output voltage is rectified only during tow vehicle speed operation to provide a charging current to a battery and where voltage is actively managed as vehicle speed increases to maintain voltage levels within predefined limits to prevent damage to the connected battery.

### BRIEF DESCRIPTION OF THE DRAWINGS

The advantages of this invention will be apparent upon consideration of the following detailed disclosure of the invention especially when taken in conjunction with the accompanying drawings wherein:

FIG. 1 is a side view of a horse-drawn, non-motorized of the type on which the present invention is advantageous;

FIG. 2A is a circuit diagram of the battery charging system of the present invention;

FIG. 2B is a partial continuation of the circuit diagram of FIG. 2A showing a portion of the battery charging system of the present invention,

FIG. 2C is a partial continuation of the circuit diagram of FIG. 2B showing a portion of the battery charging system of the present invention;

FIG. 2D is a partial continuation of the circuit diagram of FIG. 2B showing a portion of the battery charging system of the present invention:

FIG. 3 is a partial perspective view of a conventional horse-drawn carriage wheel of the type in which the generator of the battery charging system is disposed;

FIG. 4 is a partial section view of a wheel hub showing the connection of the generator to the wheel hub; and

FIG. 5 is an exploded perspective view of the wheel hub showing the generator internal components.

### DESCRIPTION OF THE PREFERRED EMBODIMENT(S)

Many of the fastening, connections processes and other means and components utilized in this invention are widely known and used in the field of the invention described, and their exact nature or type is not necessary for an understanding and use of the invention by a person skilled in the art and they will not therefore be discussed in significant detail. Also., any reference herein to the terms “left” or “right,” “up” or “down,” or “top” or “bottom” are used as a matter of mere convenience, and are determined by standing at the rear of the vehicle facing in its normal direction of travel. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures like parts are numbered the same in all of the figures.

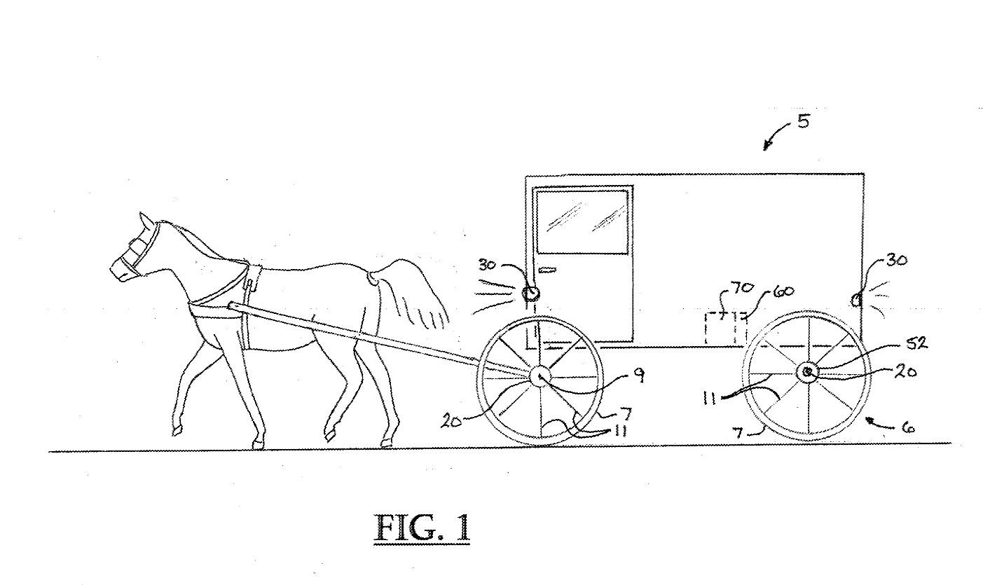

First referring to FIG. 1, shown is a horse-drawn vehicle 5 of the type on which the present invention is useful. Vehicle 5 is supported by and enabled to roll across the ground by a plurality of wheels 6 connected to the vehicle by at least one axle 9. Each wheel 6 comprises a rim 7 for contact with the ground, a plurality of spokes 11 for connecting rim 7 to a centrally located hub 20. Hub 20 provides a rotatable connection of wheel 6 to axle 9 and also a convenient location for a wheel brake apparatus. While a spoked wheel is shown as this is the most common wheel type used in a horse-drawn vehicle for which the preferred embodiment of the present invention is intended, the invention may find useful application in the hub of numerous other wheel types, including solid-disc wheels. The presentation herein is, therefore, not intended to limit application of the present invention.

For nighttime operation or other circumstances in which lighting conditions are poor, lights 30 may be added to vehicle 5. Alternatively, vehicle operators may desire to operate lighting at all times to make the vehicle more visible to motorists and other roadway users. In a non-motorized vehicle of the type discussed herein, an engine-driven electric alternator is not present, so lights 30 are generally powered by an on-board energy storage device, such as a battery 70. Without an on-board charging system, battery 70 must be periodically recharged if lights are to remain available when needed. Common practice is to use a deep-cycle battery and periodically connect the battery to an off-vehicle battery charger. Failure to periodically recharge the on-board battery could result in non-functional lights at a time when they are most needed.

The present invention addresses this problem by providing a battery charging system 50 for use in a non-motorized vehicle, such as an animal drawn carriage or buggy. Battery charging system 50 includes a synchronous generator 52 which is connected to and driven by one of the wheels 7 of the buggy, a voltage control unit 60 for converting the alternating current generator output to a direct current output suitable for charging a battery and managing the output voltage value to an ideal range suitable for charging operations on the battery 70. A non-friction, direct connected generator is preferred to minimize friction losses between the wheel and the generator input. The present invention connect generator 52 to a wheel hub using the same mounting provisions are are used to connected wheel brakes. Battery charging system 50 also includes electrical conductors for conveying electricity within the electrical circuit comprising the generator 52, voltage control unit 60, and battery 70. As the vehicle is propelled along the ground causing the wheels 7 to rotate, generator 52 is also rotated thereby causing an electrical current to be generated and directed to the battery 70.

Generator 52 is preferably a direct connected, permanent magnet, three-phase, Y-connected synchronous generator that is selected for this application based on the relatively low rotational speed of the vehicle wheels that are used to drive the generator, typically ranging between approximately 8 rpm and 205 rpm with a normal operating speed of approximately 80 rpm. These speed ranges are based upon vehicle speeds normally occurring in horse-drawn vehicles having wheels of commonly utilized diameters. Those skilled in the art will recognize that adjustment of parameters in the voltage control unit 60 or in the design of the generator 52 will enable the invention to be used in a broad array of normal wheel rotating speeds and desired output voltages. As the voltage output of a synchronous generator varies with its rotational speed, generator 52 is designed for optimal operation at a speed most frequently occurring in horse-drawn vehicle operation. Thus, generator 52 is sized and designed to produce a nominal 14.8 volts, a typical charging voltage for a conventional automotive 12 volt battery, at a vehicle speed of approximately 7 miles per hour (mph), referred to as design rated speed. In order to provide sufficient charging current to the battery at the design rated speed, generator 52 is sized to produce approximately 225 watts at the design rated speed. During operation when no electrical loads are connected to the battery, the full charging current may be directed to charging the battery. When lights or other electrical loads are connected to the battery, the generator will continue to provide a charging current to the battery which may or may not exceed the current draw on the battery. In either case, the operating time of the electrical system will be increased. If electrical loading is within the output of the charging system, the lighting loads may be operated indefinitely without depleting the battery capacity. The result is essentially that periodic off-vehicle charging (i.e., charging from an off-vehicle power source) should no longer be required.

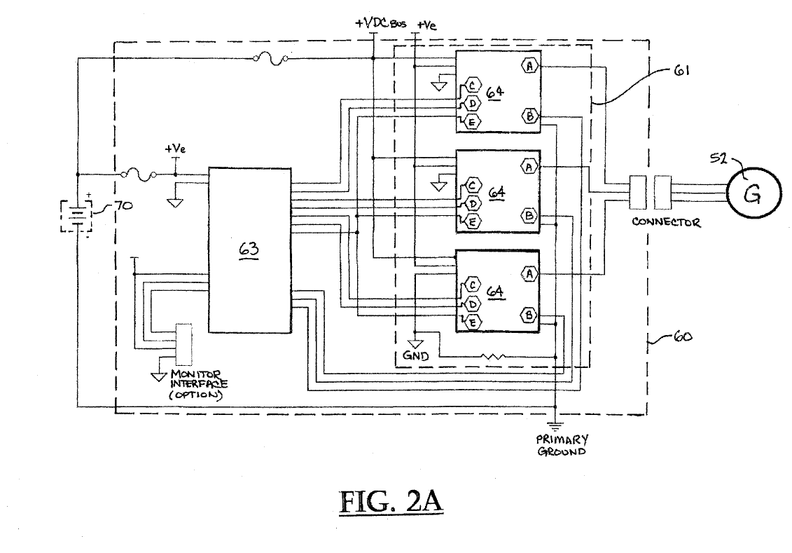

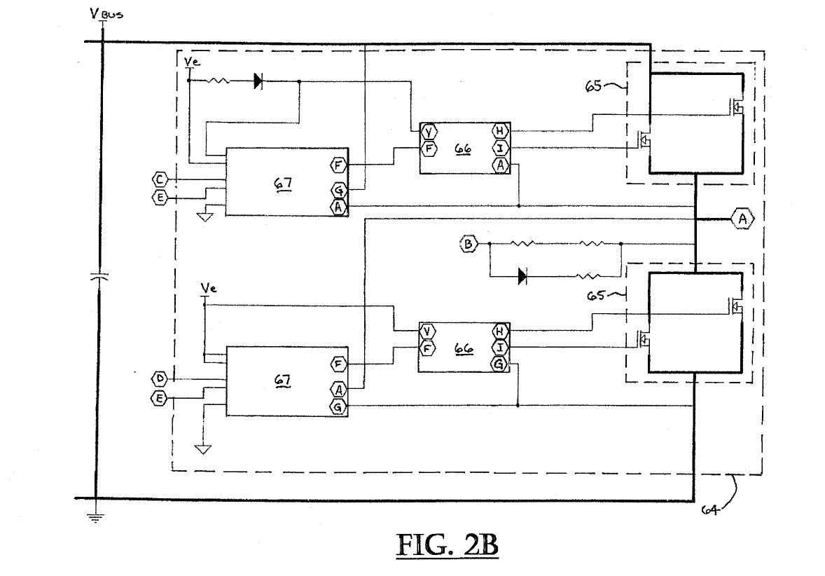

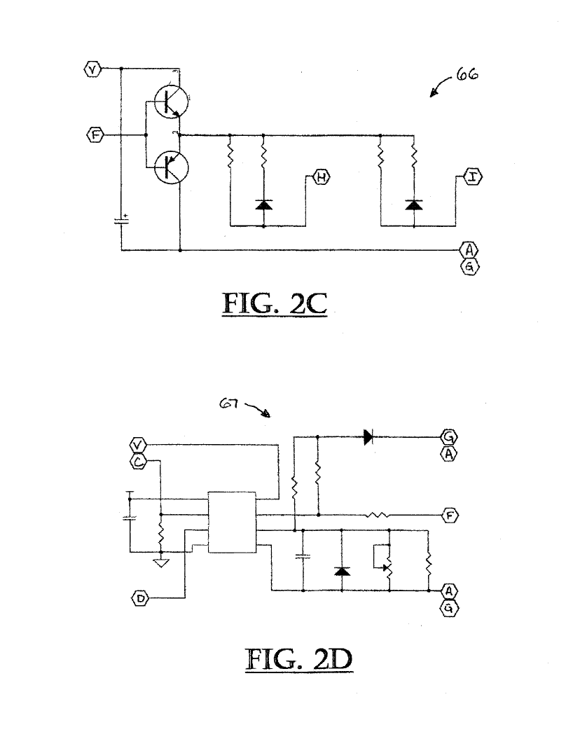

Now referring to FIGS. 2A through 2D, the electrical output of the generator 52 is managed by voltage control unit 60, which incorporates a rectifier function for converting the AC voltage output of the generator to a DC voltage suitable for charging the battery 70, and a voltage regulation function for preventing excessive voltage levels from being directed to the battery 70. The voltage control unit 60 accomplishes these functions through incorporation of switching circuitry that switch between the conventional rectifier mode of operation during conditions when output voltage from the generator 52 is less than a predefined setpoint value, and a field weakening mode of operation for conditions when generator output voltage exceeds a predetermined setpoint value. Generator output voltage ranges generally vary directly with the speed of the vehicle. In this manner, battery 70 may be substantially continuously recharged as the vehicle is operated thereby essentially eliminating the need for an off-vehicle battery charging system. The predefined setpoint value is optimally set to a voltage generally corresponding to generator operation at the design rated speed. Voltage control unit 60 may also include peripheral connections to provide indication to the operator of specific parameters that may be derived from the charging system, such as vehicle speed, charging status, lighting status, voltage levels, and the like.

Voltage control unit 60 manages the generator 52 output voltage using an active rectifier, or mode switching, circuit electrically interposed between generator 52 and battery 70. Voltage control unit 60 comprises an active rectifier 61 for converting the alternating current output of generator 52 into direct current suitable for charging battery 70. Rectifier 61 in the preferred embodiment is a three-phase, bridge circuit incorporating active switching devices, such as power MOSFETS, which are used to maintain the output voltage within a predefined limit. Voltage limiting is accomplished by the active switching devices which adjust the relative magnitudes of the individual phase currents with respect to the internally generated voltage in the stator windings caused by the rotating magnetic field created by the rotating permanent magnets in order to limit the output voltage of generator 52 at higher generator rotational speeds using pulse width modulation of the magnitude and phase of the voltages at the individual phase terminals. Control of the output voltage level is accomplished through adjustment, by the voltage control unit, of the magnitude of the out of phase currents in a feedback loop to maintain the output voltage level at or below a predefined limit. Rectifier 61 comprises three phase drive cards 64 in the preferred embodiment, each providing the bridge and switching function for a single incoming phase on a single device (integrated circuit). The phase drive cards are 64 connected to a generator control card 63, which monitors generator output performance, manages the phase balancing and switching function of the phase drive cards, and provides an easily accessible interface for generator and battery charging performance information. FIG. 28 illustrates the architecture of the phase drive card 64 which includes a pair of rectifier circuits 65, a pair gate drive cards 66 and a pair of pre-drive cards 67 arranged on the high and low side line voltages respectively, to perform the switching and rectification functions for each individual phase input from the generator. Internal circuit arrangement of the gate drive cards 66 is provided in FIG. 2C while the internal circuit arrangement of the pre-drive cards 67 is provided in FIG. 2D.

At vehicle speeds less than the design rated speed, the control unit 60 functions as a conventional full-bridge rectifier circuit to produce a direct current output that does not allow significant current flow in the reverse direction. Therefore; even though the generator 52 output voltage level may be less than the ideal battery charging voltage, the rectifier function in control unit 60 will prevent reverse current flow from discharging the battery. As vehicle speeds increase., causing a corresponding increase in generator 52 output voltage, the switching devices within control unit 60 actuate to direct a portion of the generator output to ground, referred to as a drain, in order to prevent the voltage level directed to the battery for charging from exceeding the operation limits of the battery.

It is noted that those skilled in the art may devise alternative circuits that are capable of providing a rectification function in combination with an active switching function to prevent the increasing levels generator output voltage from being wholly directed to charging the battery. The objective of such circuits is to use the switching function to drain a portion of the generator output voltage to ground to prevent subjecting the battery to an excessively high voltage level that could damage the battery. Such alternative embodiments are contemplated within the scope of the present invention as the invention as described represents the best mode of providing a switching rectifier operating at the line voltage of a permanent magnet generator.

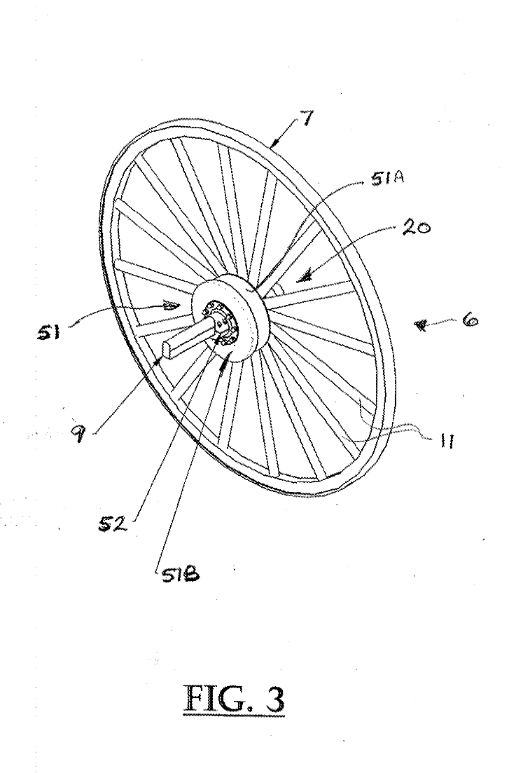

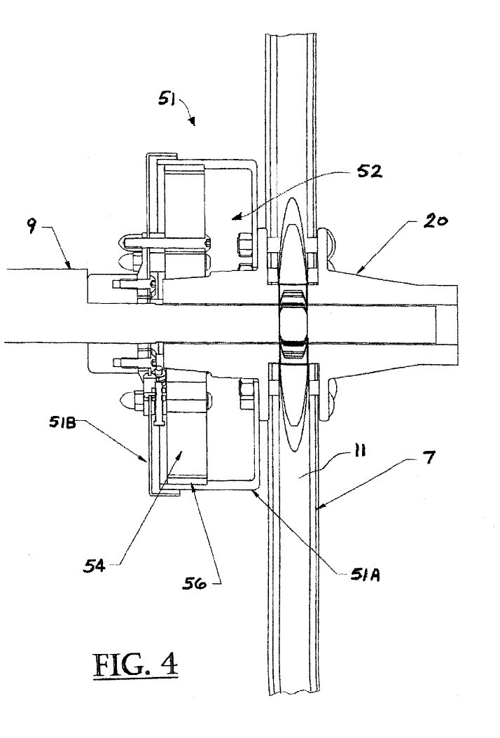

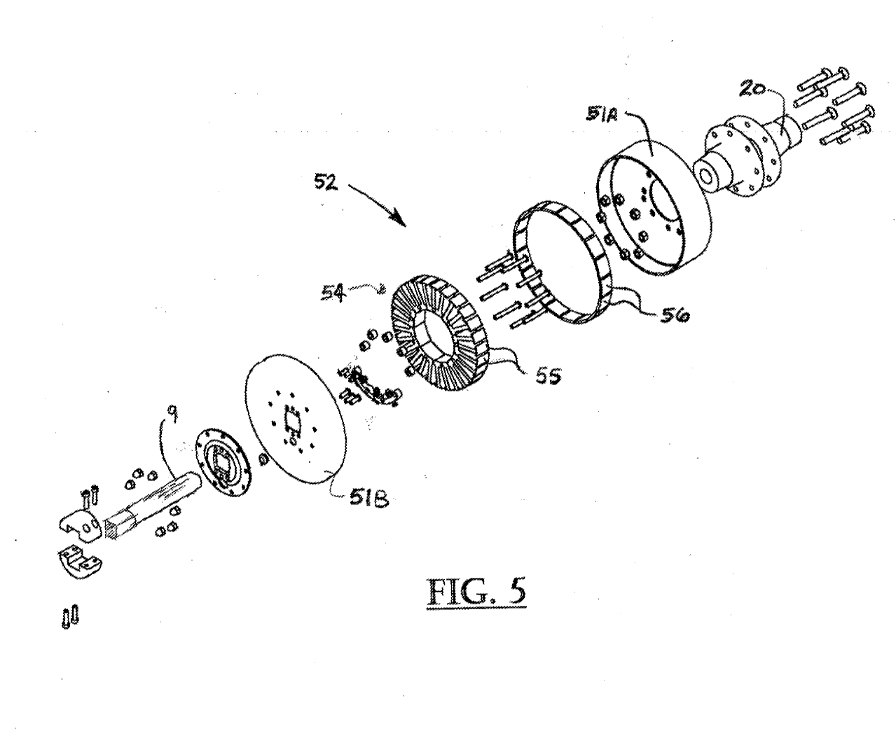

Referring to FIGS. 3 through 5, FIG. 3 presents an isometric view of wheel 6, including the hub-mounted generator 52 of the present invention, FIG. 4 provides a partial sectional view of the hub area of wheel 6 detailing the internal components of the generator 52, and FIG. 5 presents an exploded isometric view of the generator internals. A housing 51 comprising a rotating housing 51A and a fixed housing 51B is disposed at the interface between hub 20 and axle 9. Rotating housing 51A is connected to hub 20 so that it rotates as wheel 6 rotates. Fixed housing 51B is connected to axle 9 so that it remains stationary relative to rotating housing 51A. Rotating and fixed housings 51A, 51B are configured to provide a generally enclosed interior volume in which the components of generator 52 may be positioned to provide protection from the weather. In the preferred embodiment for use on a four-wheel carriage having a forward and a rearward axle, generator 52 is positioned on one of the wheels connected to the rearward axle since most carriages incorporate drum-style brakes on the forward axle wheels. Rotating housing 51A and fixed housing 51B are configured similar to a conventional drum brake housing used on horse-drawn carriages so that they may be easily fitted to hub 20 without substantial alteration of the hub since most hubs incorporate mounting provisions for a brake drum.

In the preferred embodiment, generator 52 is a synchronous multiple pole, outside rotor, rare earth permanent magnet generator. In the preferred embodiment, magnets 56 are made from Neodynium Iron Boron (NdFeB) which are powerful and, due to the plentiful availability of Neodynium (a rare earth metal commonly used for such permanent magnet motors and generators), are relatively cost effective in commercial application. Stator 54 is comprised of a plurality of concentrated wound stator poles 55 which are connected to fixed housing 51B. The stator poles are individually and externally wound and are grouped into three groups for three-phase, Y-connection operation. The preferred generator is selected for its high efficiency and readily available materials of construction. In the preferred embodiment, the outside rotor comprises 18 poles (magnets 56) while the inner stator comprises 27 individually wound poles (stator segments 55) grouped into three groups of nine for three-phase operation.

An alternative embodiment of the present invention utilizes a pair of generators 52, with one connected to the hub 20 of each wheel 6 on the forward axle of the carriage. Additional function in the voltage control unit 60 is provided to enable the generator 52 to function as a wheel braking device. In this mode, The predefined setpoint value is adjusted in a braking mode to correspond to a wheel speed less than the design rated speed, thereby configuring the voltage control unit 60 to direct more generator output energy into the energy sink, the battery 70 in this case, which increases resistance to wheel rotation and causes the wheel rotational rate to decrease. Activation of this circuit can be operator controlled through use of a brake pedal, switch, or other functionally similar means to allow the operator to selectively adjust the function of voltage control unit 60. Such an input would be directed to and managed by the generator control card 63 in the voltage control unit 60 and would be useful for supplementing a vehicle braking system. This supplemental braking function is especially useful for circumstances when the vehicle is traveling downhill and a drag force is needed to prevent the vehicle from overrunning the animal.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the inventions,

Having thus described the invention, what is claimed is:

1. A battery charging system for a ground-supported, non-motorized vehicle, the vehicle supported by a plurality of wheels connected thereto by at least one a axle, the system comprising:
a generator connected to at least one of the plurality of wheels for rotation by the wheel, said generator having a rotor and a stator for producing electric power output responsive to rotation of the wheel, said generator having at least one output conductor for conveying electric power output from said generator; and
a voltage control unit connected to said at least one output conductor, said voltage control unit receiving said electric power produced by said generator, transforming said power output to a predefined voltage having a value, and directing said power output via a charging conductor to a battery whereupon said power output restores the charge of said battery.

2. The charging system as described in claim 1, wherein said wheel further comprises a hub with a connected housing and said generator is disposed within said housing.

3. The charging system as described in claim 2, wherein said generator is a synchronous generator.

4. The charging system as described in claim 3, wherein said generator is a three-phase, Y-connected generator.

5. The charging system as described in claim 4, wherein said voltage control unit further comprises a rectifier, said rectifier converting said electric power output in alternating current form to a direct current output suitable for charging said battery, and managing said output voltage value to an ideal range suitable for charging said battery.

6. The charging system as described in claim 5, wherein said voltage control unit further comprises a switch, a transition voltage value being pre-defined within said control unit, a first operation mode, and a second operation mode, said power output having a voltage varying generally with the rotational speed of the wheel, said control unit operating in said first operational mode when said power output voltage is generally less than said transition voltage value and operating in said second operation mode when said power output voltage is generally equal to or greater than said transition voltage value.

7. The charging system as described in claim 6, wherein said voltage control unit comprises integrated semi-conductor circuits for operation in said first and second operational modes.

8. The charging system as described in claim 7, wherein said vehicle is a animal-drawn vehicle,

9. The charging system as described in claim 8, further comprising at least two generators, each connected to an individual wheel wherein said charging system is selectably switchable to cause said generators to resist wheel rotation sufficiently to enable said charging system to provide a vehicle braking force while charging the battery.

10. A battery charging system for a ground-supported, non-motorized animal-drawn vehicle, the vehicle supported by a plurality of wheels connected thereto by an axle, the system comprising:
a hub for rotatably connecting at least one of the plurality of wheels to the axle, said hub rotating as the vehicle is moved across the ground;
a generally cylindrically-shaped housing structure connected to said hub and rotating with said hub, said housing structure having an interior and an exterior surface;
a generator rotor disposed generally adjacent said interior surface perimeter of said housing structure to define a generally cylindrical, centrally disposed interior region and a generator stator connected to the axle and disposed within said interior region, said rotor and stator combining to form an electric power generator having an output voltage caused by and varying with the rate of rotation of said hub;
at least one output conductor; and
a voltage control unit connected to said at least one output conductor, said voltage control unit receiving said electric power produced by said generator, transforming said power output to a predefined voltage having a value, and directing said power output via a charging conductor to a battery whereupon said power output restores the charge of said battery.

11. The charging system as described in claim 10, wherein said generator is a synchronous generator.

12. The charging system as described in claim 11, wherein said generator is a three-phase, Y-connected generator.

13. The charging system as described in claim 12, wherein said voltage control unit further comprises a rectifier, said rectifier converting said electric power output in alternating current form to a direct current output suitable for charging said battery, and managing said output voltage value to an ideal range suitable for charging said battery.

14. The charging system as described in claim 13, wherein said voltage control unit further comprises a switch, a transition voltage value being pre-defined within said control unit, a first operation mode, and a second operation mode, said power output having a voltage varying generally with the rotational speed of the wheel, said control unit operating in said first operational mode when said power output voltage is generally less than said transition voltage value and operating in said second operation mode when said power output voltage is generally equal to or greater than said transition voltage value.

15. The charging system as described in claim 14, wherein said voltage control unit comprises integrated semi-conductor circuits.

16. The charging system as described in claim 15, further comprising at least two generators connected to at least two wheels on the vehicle, said wheels being disposed on opposing ends of a single axle, said at least two generators each having an electrical output connector connected to said voltage control unit.

17. The charging system as described in claim 16, wherein said voltage control unit may be selectively configured to increase the power output from said at least two generators thereby allowing said generators to function as a regenerative vehicle braking system.

18. A method for charging a battery on a non-motorized vehicle supported by a plurality of wheels comprising the steps:
providing a ground-supported vehicle supported by a plurality of wheels connected thereto by at least one axle;
providing a generator connected to at least one of the plurality of wheels for rotation by the wheel, the generator having a rotor and a stator for producing electric power output responsive to rotation of the wheel, the generator having at least one output conductor for conveying electric power output from the generator;
providing a voltage control unit connected to the at least one output conductor, the voltage control unit receiving electric power produced by the generator;
moving the vehicle by non-motorized means to cause rotation of the wheel and connected generator thereby producing electric power output having a voltage;
conducting by the at least one output conductor, the power output to the voltage control unit;
transforming, by the voltage control unit, the power output to a predefined voltage having a value; and
directing the power output via a charging conductor to a battery whereupon the power output restores the charge of the battery.

19. The method of claim 16, wherein the generator is a synchronous, three-phase, Y-connected generator having an alternating current output.

20. The method of claim 17, further comprising the steps, transforming, by the voltage control unit the three-phase, alternating current output of the generator to direct current suitable for charging the battery; and
managing the output voltage value to an ideal range suitable for charging the battery by limiting the output voltage value to less than or equal to a predefined value.
